(19) United States
(12) Patent Application Publication
(10) Pub. No.: US 2005/0047719 A1
(43) Pub. Date: Mar. 3, 2005

(54) Optical transmitter / transceiver

(76) Inventors: Atul Srivastava, Marlboro, NJ (US); Yan Sun, Sunnyvale, CA (US); Gordon Wilson, San Francisco, CA (US)

Correspondence Address: Jeffery J. Brosemer, Ph.D., ESQ., 138 S. Telegraph Hill Road, Holmdel, NJ, 07733, US

(21) Appl. No.: 10/653,724

(22) Filed: Sep. 2, 2003

(51) Int. Cl. G02B 6/26; G02B 6/34; H01S 3/14

(52) U.S. Cl. 385/39; 385/37; 372/39

(57) ABSTRACT

An optical transmitter/transceiver that includes a gain medium having a sufficiently highly reflective surface at one end, a sufficiently anti-reflective surface at another opposite end, and an attachable/detachable wavelength-selective reflection mechanism which when coupled to the gain medium effectively becomes part of a laser cavity. A transmitter/transceiver module that includes a number of these optical transmitter/transceivers provides a multi-wavelength output source, depending upon the attachable/detachable wavelength-selective reflection mechanism chosen for a particular transmitter/transceiver.

### FIELD OF THE INVENTION

This invention relates generally to the field of optical communications and in particular to an optical transmitter/transceiver suitable for use in single channel, or multiple-channel wavelength division multiplexed (WDM) communications systems.

### BACKGROUND OF THE INVENTION

Optical communication systems oftentimes use wavelength-division multiplexing to increase transmission capacity. More specifically, a plurality of optical signals each having a different wavelength are multiplexed together into a WDM signal. The WDM signal is transmitted over a transmission line, and then subsequently demultiplexed so that individual optical signals may be individually received.

The ability to efficiently provide such WDM communications and high-performance single channel systems is, of course, greatly dependent upon the ability to fabricate suitable optical transmitters/transceivers. Such optical transmitters/transceivers should be easily constructed at a relatively low cost, provide greater reliability thereby exhibiting ease of maintenance, exhibit lower chirp as compared to existing technologies, provide stable wavelength operation over a broad range of temperatures and may advantageously further speed up optical system throughput over longer geographic distances while providing greater system capacity. Such optical transmitters/transceivers are the subject of the invention.

### SUMMARY OF THE INVENTION

We have invented an optical transmitter/transceiver and associated optical system module that offers a number of advantages over existing optical transmitters/transceivers and related system modules. Advantageously, and in sharp contrast to prior art optical transmitters/transceivers, the transmitter/transceiver which is the subject of the present invention exhibits lower chirp as compared with alternative, existing technologies; provides stable wavelength operation over a broad range of operating temperatures thereby enabling wavelength division multiplexing having closer channel spacing than existing coarse wavelength division multiplexing (CWDM) systems—while enhancing transmission system capacity and providing greater transmission distances at a given wavelength(s).

Viewed from a first aspect, our invention is directed to an optical transmitter/transceiver that includes a suitable gain medium having a sufficiently highly reflective surface at one end, a sufficiently anti-reflective surface at another, opposite end, and an attachable/detachable, wavelength-selective reflection mechanism.

Viewed from another aspect, our invention is directed to a transmitter/transceiver module that includes a number of our inventive optical transmitter/transceivers, each one coupled via connector in an attachable/detachable manner, to a wavelength-selective reflection mechanism such that each of the individual transmitter/transceivers of the module emits at a desired wavelength. Advantageously, each of the desired wavelengths may be different or not, depending upon the overall system requirements and the attachable/detachable, wavelength-selective reflective mechanism.

In this transmitter/transceiver module configuration, the module may further include a multiplexer and additional control electronics, thereby providing a multi-wavelength output suitable for a number of optical applications.

Viewed from yet another aspect, our invention is directed to modular, transmitter/tranceiver packages which may fully exploit the other aspects of our inventive teachings.

Additional objects and advantages of our invention will be set forth in part in the description which follows, and, in part, will be apparent from the description or may be learned by practice of the invention.

### BRIEF DESCRIPTION OF THE DRAWING

FIG. 1 is a schematic representation of an optical transmitter/transceiver constructed according to the teachings of the present invention;

FIG. 2 is a schematic representation of an alternative embodiment of an optical transmitter/transceiver constructed according to the teachings of the present invention;

FIG. 3 is a schematic representation of an optical transmitter/transceiver module constructed according to the teachings of the present invention;

FIG. 4 is a schematic representation of an alternative arrangement of the optical transmitter/transceiver module shown in FIG. 3;

FIG. 5 is a schematic representation of a wavelength-selective reflection assembly according to the present invention; and

FIG. 6 is a schematic representation of an alternative arrangement of a wavelength-selective reflection assembly according to the present invention.

### DETAILED DESCRIPTION

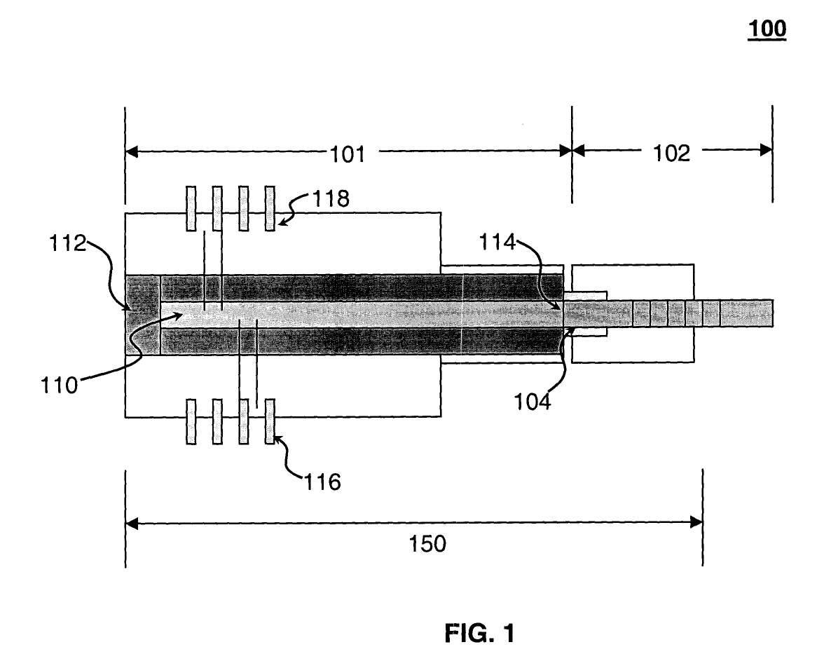

With reference now to FIG. 1, there is shown in schematic form an optical transmitter/transceiver 100, which exhibits our inventive teachings. More specifically, optical transmitter/transceiver 100 includes three principal assemblies namely, laser assembly 101 and attachable/detachable wavelength-selective reflection assembly 102, which are optically coupled by attachable/detachable connector assembly 104.

Clarification regarding nomenclature and its usage herein is appropriate at this time. As used in this description, we have used the terminology “transmitter/transceiver” throughout to describe what is shown in the drawing. Those skilled in the art will quickly appreciate that our invention may be advantageously practiced as transmitters (as generally shown), or in combination with receivers housed in a same package, i.e., transceivers. Accordingly, nothing in this specification should be read as being so limiting.

Returning now to FIG. 1 and as shown therein, laser assembly 101 includes a gain medium 110 interposed between a sufficiently highly reflective (HR) component at one end 112 and sufficiently anti-reflective (AR) component 114 at another, opposite end which is attachably/detachably connected to wavelength-selective reflection assembly, 102. This combination of elements, gain medium 110, highly reflective component 112, anti-reflective component 114, and wavelength-selective reflection assembly 102—and their relative positioning—form the skeleton of a laser and its cavity, and are selected to generate and reflect light waves such that they reinforce each other. Of course, those skilled in the art will quickly appreciate that any of a number of gain medium materials and highly reflective and anti-reflective materials along with wavelength-selective reflection mechanisms, i.e., fiber gratings, may be chosen such that a desired wavelength output is produced.

In operation, energy sufficient to excite the gain medium and thereby initiating lasing action may be provided, for example, through electrical connections 116 and 118. Still further, and as shown in this FIG. 1, the overall laser cavity 150 is defined by the region extending from the highly reflective component 114, to a point in the attachable/detachable wavelength-selective reflection assembly 102, such that a desired and suitable output wavelength is produced as a result of the lasing action.

At this point, it should be apparent to those skilled in the art the flexibility of our invention. Specifically, a number of output wavelengths may be possible through appropriate selection of any one or all of: gain medium, reflection component(s), and/or attachable/detachable wavelength-selective reflection assembly. Still further, and as a result of our inventive attachable/detachable wavelength-selective reflection assembly, the output and/or operating characteristics of our invention may be selectively changed simply by coupling an attachable/detachable wavelength-selective reflection assembly having different selection and/or reflection characteristics. In this inventive manner, a highly flexible, field-configurable/reconfigurable device is realized.

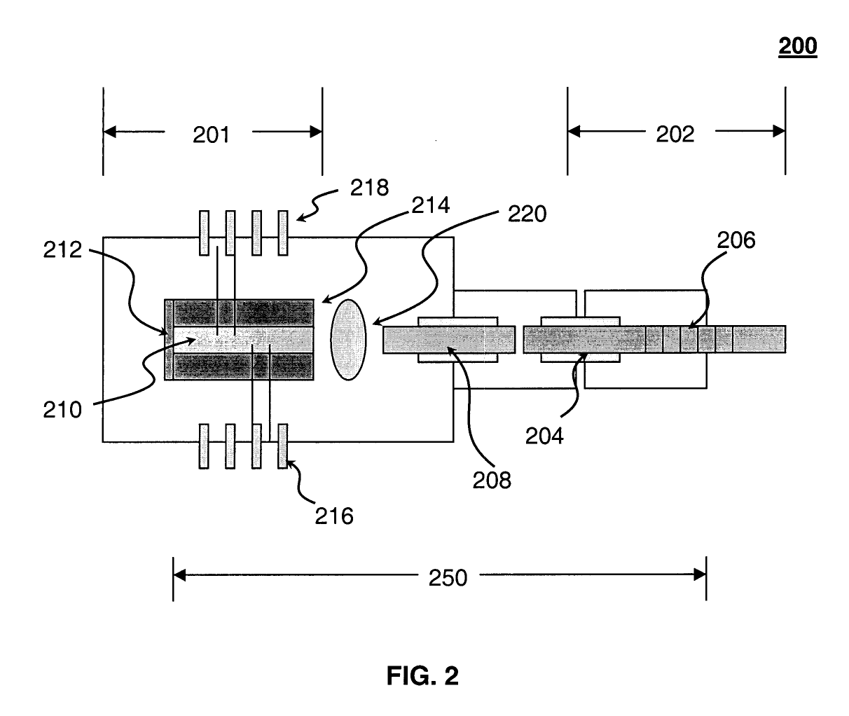

With reference now to FIG. 2, there is shown an alternative arrangement of an optical transmitter/transceiver exhibiting our inventive teachings. More specifically, optical transmitter/transceiver 200 includes the three principal assemblies identified earlier, namely, laser assembly 201, attachable/detachable wavelength-selective reflection assembly 202, and attachable/detachable connector assembly 204 which optically couples the laser assembly to the wavelength-selective reflection assembly.

Continuing with our description of the assembly shown in FIG. 2, laser assembly 201 includes a gain medium 210 interposed between a highly reflective (HR) component at one end 212 and anti-reflective (AR) component 214 at another, opposite end. As before, energy sufficient to excite the gain medium and thereby initiate lasing action may be provided through electrical connections 216 and 218.

In this configuration, laser light emanates from anti-reflective end where it is focused by lens 220 such that it is optically directed to optical coupling fiber 208, which further couples the laser light into wavelength-selective reflection assembly which, in this instance may comprise fiber grating 206.

As shown in this FIG. 2, the fiber grating 206 is attachably/detachably connected to the laser assembly by attachable/detachable connector assembly, 204. When assembled in this manner, the overall, effective laser cavity is defined by region 250, which is generally the optical path between a point in the fiber grating 206 and the HR end 212 of the laser assembly.

Although it is not specifically shown in this FIG. 2, the connector assembly 204 may include a pair of mated connector components such that a sufficient and reliable mechanical/optical connection is made. Those skilled in the art will appreciate that the choice of such connector(s) is a matter of design choice.

As can be readily appreciated, when assembled in this manner wherein the fiber grating 206 (wavelength-selective reflection mechanism) is coupled to the laser assembly and made part of the overall laser cavity through the action of connector assembly 204, the characteristics of the transmitter/transceiver such as output wavelength may be advantageously changed by simply connecting a different wavelength-selective reflection mechanism.

The output of such an optical transmitter/transceiver 200 may be individually, or in combination, directed to a multiplexer for further treatment depending upon the particular optical application.

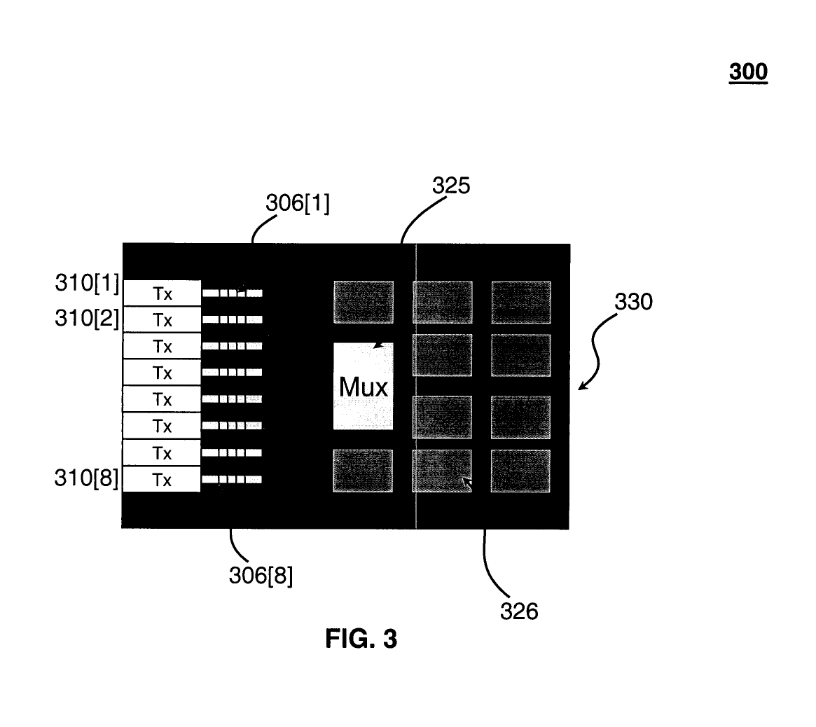

With reference now to FIG. 3, there is shown a transmitter/transceiver module 300, employing an array of optical transmitters 310[1] . . . 310[8] each including a respective wavelength-selective reflection assembly 306[1] . . . 306[8] thereby producing outputs at different, respective wavelengths λ[1] . . . λ[8]. In such a module 300, the outputs λ[1] . . . λ[8] may be multiplexed through the action of multiplexer 325, and subsequently output as a multiwavelength signal 330 under the control of control electronics 326. Not specifically shown in this FIG. 3, but nevertheless part of our inventive teachings, are connector assemblies that attachably/detachably connect the individual wavelength-selective reflection elements to respective transmitters.

Control electronics may monitor and/or adjust a variety of operating parameters such as power and temperature and advantageously may be implemented by a variety of known electronic control systems and or mechanisms. Additionally, and not readily apparent from the FIG. 3, each of the optical transmitters 310[1] . . . 310[8] may advantageously be interchangeable with one another. Lastlly, while only eight transmitters are shown in this FIG. 3, it is understood by those skilled in the art that the number of such transmitters comprising the transmitter/transceiver module is a matter of design choice and may be expanded/reduced as appropriate to a particular design.

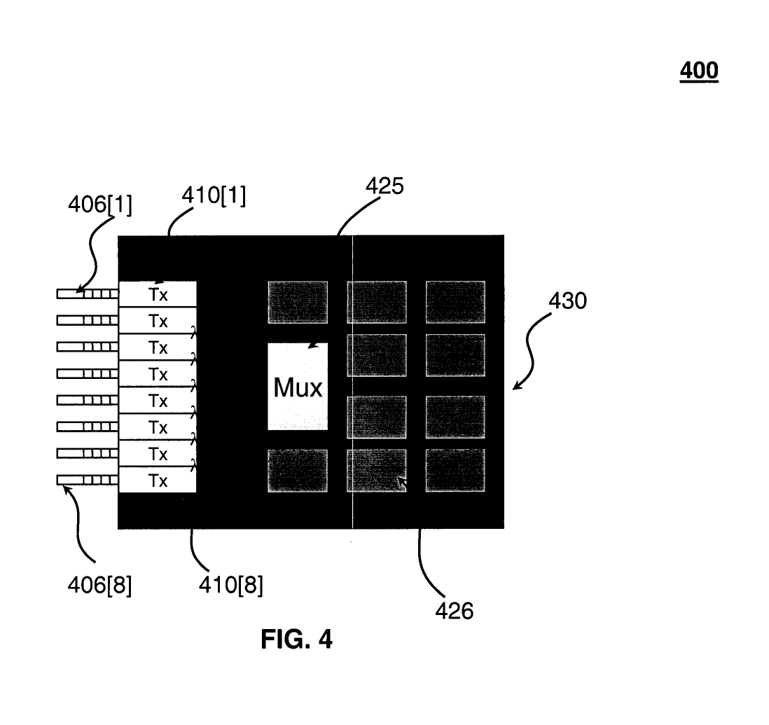

With reference now to FIG. 4, there is shown an alternative embodiment of our invention as incorporated into a transmitter/transceiver module 400. Similar to apparatus shown in FIG. 3, the transmitter/transceiver module 400 shown in FIG. 4, employing an array of optical transmitters 410[1] . . . 410[8] each including a respective wavelength-selective reflection assembly 406[1] . . . 406[8] thereby producing outputs at different, respective wavelengths λ[1] . . . λ[8]. In such a module 400, the outputs λ[1] . . . λ[8] may be multiplexed through the action of multiplexer 425, and subsequently output as a multiwavelength signal 430 under the control of control electronics 426. As was the case in FIG. 3, the connector assemblies that attachably/detachably connect the transmitters 410[1] . . . 410[8] to respective wavelength-selective reflection elements 406[1] . . . 406[8].

As should be readily apparent from the configuration of module 400, the wavelength-selective reflection assemblies 406[1] . . . 406[8], are not interposed between the transmitters 410[1] . . . 410[8] and the multiplexer 425. Highlighting one aspect of the flexibility of our invention and its implementation(s), the wavelength-selective reflection assemblies 406[1] . . . 406[8] may be attachably connected to an end other than the output end of the laser assembly. In this inventive manner, modules may be constructed such that they are easily field-reconfigurable.

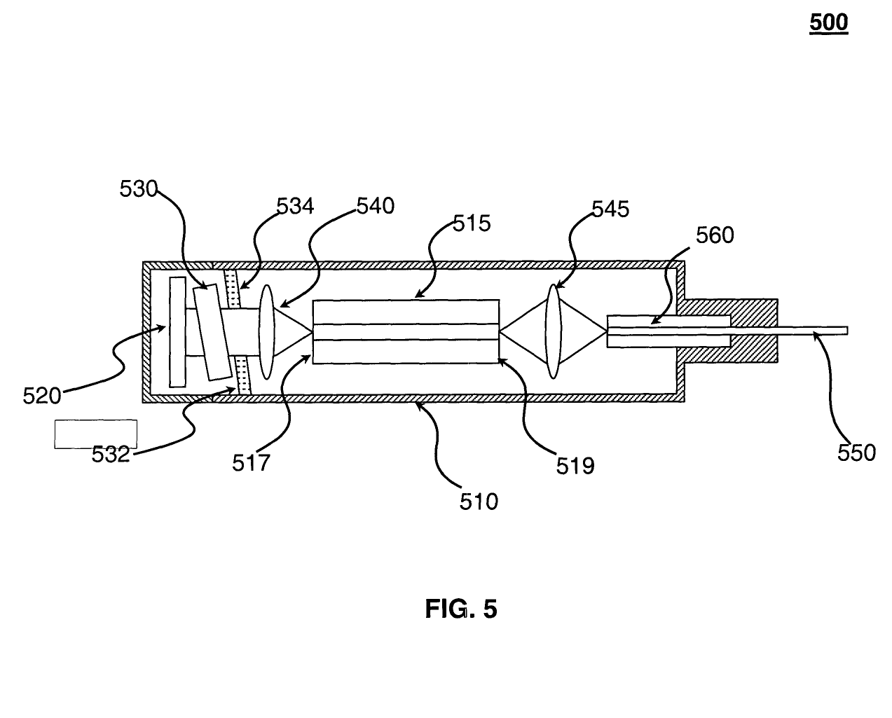

Turning now to FIG. 5, there is shown a first alternative transmitter/transceiver embodiment wherein housing 510 includes gain medium 515 having an anti-reflective coating 517 on a first end and reflector/coupler 519 at another, opposite end. Adjacent to the anti-reflective end is lens 540 which couples light between gain medium 515 and tilted, narrowband thin-film filter 530 and further to broadband reflector 520. Interposed between the tilted narrowband thin-film filter 530 are anti-reflection coated windows 534 and 535.

Light exiting reflector/coupler 519 end of gain medium 515 is coupled into optical fiber 550 by coupling lens 545. Advangageously, output fiber 550 may be inserted into ferrule 560 which may facilitate alignment. As could be readily appreciated, this entire assembly 500 may be “unplugged” from an output fiber 550 and replaced with a different a replacement assembly 500 exhibiting the same, or different output wavelength characteristics, depending upon the specific application.

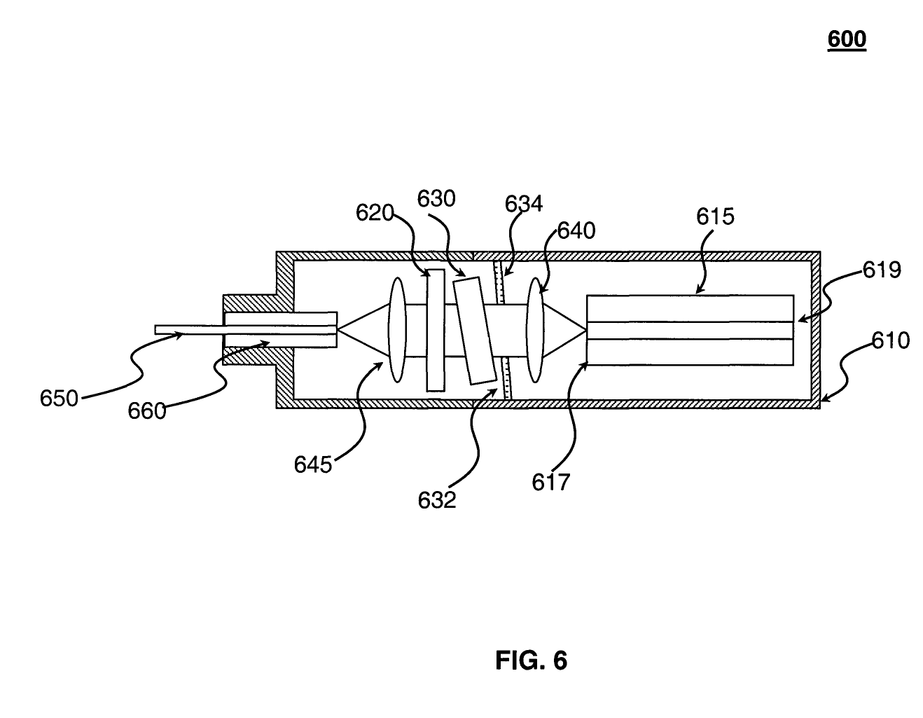

Additional flexibility in our inventive designs is further apparent with reference to FIG. 6. There is shown a transmitter/transceiver 600 having housing 610 in which is placed gain medium 615 having a highly reflective coating on one end 619 and anti-reflective coating on another, opposite end 617. In this configuration, light exiting the gain medium 615 via anti-reflective 617 end is collected by lens 640 where it then passes through anti-reflection coated windows 632, 634 before passing through tilted narrowband thin-film filter 630, then broadband partial reflector 620 where it is subsequently coupled into output fiber 650 through the action of coupling lens 645. As with the assembly shown in FIG. 5, this transmitter/transceiver assembly 600 includes ferrule 660 into which output fiber 650 is inserted to facilitate its alignment.

With this arrangement, like those shown prior, when sufficient energy, i.e., electrical energy is applied lasing is initiated and light of a desired wavelength is emitted.

As can be readily appreciated by those skilled in the art, with this further alternative embodiment, rear portion of housing 610 may be detached such that gain medium 615 may be advantageously exchanged/replaced without affecting the remaining optical components. Of course, the entire assembly 600 may be “unplugged” from the output fiber 650 and replaced in its entirety.

Of course, it will be understood by those skilled in the art that the foregoing is merely illustrative of the principles of this invention, and that various modifications can be made by those skilled in the art without departing from the scope and spirit of the invention.

1. A optical device comprising:
a gain medium having a highly-reflective end and an anti-reflective end; and
an attachable/detatchable wavelength-selective reflection mechanism which, when connected to the gain medium, becomes part of and defines a laser cavity sufficient to support lasing.

2. The optical device according to claim 1 further comprising a connector assembly for connecting the attachable/detachable wavelength-selective reflection mechanism to the gain medium.

3. The optical device according to claim 2 wherein said attachable/detachable wavelength-selective reflection mechanism includes a fiber grating.

4. The optical device according to claim 2 further comprising electrical connections in electrical communication with the gain medium such that when sufficient electrical energy is applied to the connections, lasing is initiated.

5. The optical device according to claim 2 wherein said connector assembly includes a mated pair of connector components.

6. The optical device according to claim 2 further comprising a coupling lens interposed between the anti-reflective end of the gain medium and the attachable/detachable wavelength-selective reflection mechanism.

7. The optical device according to claim 6 further comprising a coupling fiber interposed between the coupling lens and the attachable/detachable wavelength-selective reflection mechanism.

8. An optical device comprising:
an array of optical transmitters each one of the array including
a gain medium having a highly reflective end and an anti-reflective end; and
an attachable/detachable wavelength-selective reflection mechanism which, when connected to the gain medium, becomes part of and defines a laser cavity sufficient to support lasing.

9. The optical device according to claim 8 wherein each one of said optical transmitters emits a desired wavelength of light.

10. The optical device according to claim 9 further comprising one or more connectors for attachably/detachably connecting the optical transmitters to the optical device.

11. The optical device according to claim 8 wherein each of the optical transmitters have a connector assembly for connecting the attachable/detachable wavelength-selective reflection mechanism to the gain medium.

12. The optical device according to claim 11 wherein at least one of the attachable/detachable wavelength-selective reflection mechanisms includes a fiber grating.

13. The optical device according to claim 9 further comprising an optical multiplexer for multiplexing the light emitted from the transmitters.

14. The optical device according to claim 11 wherein the attachable/detachable wavelength-selective reflection mechanisms are connected to the gain medium at an end through which light is emitted.

15. The optical device according to claim 11 wherein the attachable/detachable wavelength-selective reflection mechanisms are connected to the gain medium at an end opposite to that end through which light is emitted.

16. A optical device comprising:
a gain medium having an anti-reflective end and reflective/coupling end;
a broadband reflector;
a tilted, narrowband filter interposed between the broadband reflector and the anti-reflective end of the gain medium;
a lens, interposed between the narrowband filter and the anti-reflective end of the gain medium for coupling light therebetween; and
one or more anti-reflection coated windows interposed between the lens and the narrowband filter; and
such that the region between the reflector/coupler end of the gain medium and the broadband reflector defines a laser cavity sufficient to support lasing.

17. The optical device according to claim 16 further comprising an output fiber optically coupled to the gain medium such that when lasing is initiated in the laser cavity output light is emitted and coupled into the output fiber.

18. The optical device according to claim 17 wherein said output fiber is attachably/detachably connected to the gain medium.

19. The optical device according to claim 18 further comprising a coupling lens, interposed between the gain medium and the output fiber for optically coupling emitted light into the output fiber.

20. A optical device comprising:
an output optical fiber attachably/detachably connected to
a housing containing:
a gain medium having an anti-reflective end and a highly reflective end;
a broadband partial reflector;
one or more anti-reflection coated windows interposed between the reflector and the anti-reflective end of the gain medium;
a collection lens interposed between the anti-reflection windows and the gain medium; and
a tilted, narrowband filter interposed between the anti-reflection windows and the partial reflector;
such that the region between the highly reflective end of the gain medium and the broadband partial reflector defines a laser cavity sufficient to support lasing.

21. The optical device according to claim 20 further comprising a coupling lens, interposed between the broadband partial reflector and the output fiber for optically coupling emitted light into the output fiber.
